(19) United States
(12) Patent Application Publication
(10) Pub. No.: US 2026/0130353 A1
(43) Pub. Date: May 14, 2026

(54) INSECT HARVESTER

(71) Applicant: Randy J. Sasaki, Denver, CO (US)

(72) Inventor: Randy J. Sasaki, Denver, CO (US)

(21) Appl. No.: 19/232,399

(22) Filed: Jun. 9, 2025

Related U.S. Application Data
(60) Provisional application No. 63/720,253, filed on Nov. 14, 2024.

(51) Int. Cl. A01M 1/22; A01M 1/02; A01M 1/04; A01M 1/10

(52) U.S. Cl. CPC A01M 1/223; A01M 1/023; A01M 1/04; A01M 1/10

(57) ABSTRACT

A unique insect harvester design provides for attracting and killing insects in a manner that preserves their nutrition for use as animal feed. In some implementations, an insect harvester unit can include various insect attractants, including light, sound, tactile movement, chemicals, or any combination thereof, to attract insects. The insect harvester unit may further comprise a printed circuit board (PCB) that includes some or all of these attractants, as well as exposed conductive tines. The content and/or operation of the attractants, as well as the voltage of the conductive tines, may be specially tuned to attract and kill one or more types of targeted insects. The insect harvester unit may further be operated in a manner that avoids killing pollinating insects, and safely turns off in the presence of rain or other moisture.

### RELATED APPLICATIONS

This application claims the benefit of U.S. Provisional Application No. 63/720,253, filed Nov. 14, 2024, entitled “INSERT HARVESTER PANEL,” which is assigned to the assignee hereof, and incorporated herein in its entirety by reference.

### BACKGROUND

Animal nutrition is fundamental to global food security, driving efficient production in both livestock and aquaculture. Optimized feeding, particularly regarding protein, is crucial for animal productivity and converting feed into essential meat, milk, eggs, and fish for a growing population. With traditional protein sources facing sustainability challenges, there is a critical need for alternative ingredients.

Insects are a promising alternative protein for animal feed, offering high protein and requiring fewer resources like land and water, while also being capable of converting organic waste. Despite this potential, traditional insect growing and harvesting methods are inefficient, inconsistent, and prone to contamination, underscoring the necessity for modern, controlled farming and processing techniques to integrate insects reliably into sustainable food systems.

### BRIEF SUMMARY

Embodiments described herein provide a unique insect harvester design that can attract and kill insects in a manner that preserves their nutrition for use as animal feed. To attract insects, an insect harvester unit can include various insect attractants, including light, sound, tactile movement, chemicals, or any combination thereof. The insect harvester unit may further comprise a printed circuit board (PCB) that includes some or all of these attractants, as well as exposed conductive tines. The content and/or operation of the attractants and the conductive tines'voltage may be specially tuned to attract and kill one or more types of targeted species of insects. The insect harvester unit may further be operated in a manner that avoids killing pollinating insects, and safely turns off in the presence of rain or other moisture. These and other features are described in the embodiments herein.

An example device for harvesting insects, according to this disclosure, comprises a printed circuit board (PCB) having a surface, and a plurality of exposed conductive tines extending along the surface of the PCB. The plurality of exposed conductive tines comprises a first set of tines interleaved with a second set of tines, the first set of tines and the second set of tines being electrically connected with different electrical nodes such that, during operation of the device, a voltage is created between the first set of tines and the second set of tines during operation of the device.

The device for harvesting insects may include one or more of the following features. The device may further comprise one or more insect attractants disposed on the surface of the PCB. The one or more insect attractants may comprise one or more light sources. The one or more light sources may comprise at least one light emitting diode (LED), at least one electroluminescent light, or a combination thereof. The one or more light sources may comprise the at least one light emitting diode (LED), and the at least one LED is configured to emit light having a wavelength between 365-550 nm. According to some embodiments, the one or more insect attractants may comprise a speaker configured to generate one or more frequencies between 300-550 Hz. The plurality of exposed conductive tines may comprise conductive traces of the PCB. The device may be configured to operate such that the voltage created between the first set of tines and the second set of tines during operation of the device is between substantially 80-185 V. Tines of the first set of tines may extend along the surface of the PCB substantially parallel to tines of the second set of tines. A spacing between a tine of the first set of tines and a tine of the second set of tines may be between 100-500 mils. The PCB further includes holes for mounting an insect-collecting apparatus to the device. According to some embodiments, the device for harvesting insects may include a solar pane, a battery configured to receive and store power from the solar panel, control circuitry configured to receive power from the battery and provide the voltage to the PCB, and a compartment housing the control circuitry, the battery, or both. One or more chemical insect attractants may be located inside the compartment. The device may further comprise a moisture sensor and a light sensor. The control circuitry may be configured to provide the voltage to the PCB based at least in part on an indication, from the light sensor, that a level of light measured at the device is lower than a certain threshold, and an indication, from the moisture sensor, that a level of moisture measured at the device is lower than a certain threshold.

An example method of operating a device for harvesting insects, according to this disclosure, comprises providing, with control circuitry, electrical power to a printed circuit board (PCB). The PCB may comprise a plurality of exposed conductive tines extending along a surface of the PCB, the plurality of exposed conductive tines comprising a first set of tines interleaved with a second set of tines. The first set of tines and the second set of tines may be electrically connected with different electrical nodes such that a voltage is created between the first set of tines and the second set of tines when the electrical power is provided to the PCB.

The method may include one or more of the following features. The method may further comprise operating one or more light sources located on the surface of the PCB, the one or more light sources comprising at least one light emitting diode (LED), at least one electroluminescent light, or a combination thereof. The method may further comprise operating a speaker, located on the surface of the PCB, to generate one or more frequencies between 300-550 Hz. Providing the electrical power may comprise providing the voltage, wherein the voltage is between substantially 80-185 V. The control circuitry may be coupled with a light sensor, and providing the electrical power to the PCB may be based, at least in part, on an indication from the light sensor to the control circuitry that a level of light measured at the device is lower than a certain threshold. The control circuitry may be coupled with a moisture sensor, and providing the electrical power to the PCB may be based, at least in part, on an indication from the moisture sensor to the control circuitry that a level of moisture measured at the device is lower than a certain threshold.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an image of an example insect harvesting unit, according to an embodiment.

FIG. 2 is a block diagram of the electrical components of an example insect harvesting unit, which may correspond to the example insect harvesting unit of FIG. 1.

FIG. 3 is a perspective drawing of the front of an insect harvesting unit, according to an embodiment.

FIG. 4A is a drawing of the back of an insect harvesting unit, according to an embodiment.

FIG. 4B is a drawing of a side view of an insect harvesting unit, according to an embodiment.

FIG. 5 is a drawing of a front view of a harvesting PCB, according to an embodiment.

FIG. 6 is a drawing of a back view of the harvesting PCB illustrated in FIG. 5.

FIG. 7 is an illustration of a side view of an insect harvesting unit (similar to FIG. 4B), with modifications, according to an embodiment.

FIG. 8 is an illustration of yet another configuration of an insect harvesting unit 100, according to an embodiment.

FIG. 9 is an illustration of another configuration of an insect harvesting unit, according to an embodiment.

FIG. 10 is an illustration of another configuration of an insect harvesting unit, according to an embodiment.

FIG. 11 is a flow diagram of a method for operating a device for harvesting insects, such as one or more harvesting PCBs as described herein, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations to describe innovative aspects of various embodiments. However, a person of ordinary skill in art will readily recognize that the teachings herein can be applied in a multitude of different ways. The described implementations may be implemented in various contexts, including construction sites that do not involve solar construction, as well as other industrial, commercial, military, or residential use cases, to name only a few.

It will be apparent to those skilled in the art that substantial variations may be made in accordance with specific requirements. For example, although specific materials, elements, configurations, and/or other aspects of the embodiments described herein may be described, a person of ordinary skill in the art will appreciate that alternative materials, elements, etc. may be used. Such variations from the embodiments described herein may be based on a variety of factors, including worksite requirements, budgetary requirements, manufacturing limitations, or the like.

Animal nutrition is integral to global food production systems, encompassing both traditional terrestrial livestock farming and aquaculture. Ensuring a reliable and efficient supply of animal-sourced food for a growing human population necessitates optimized feeding strategies for a diverse range of domesticated animal species, including poultry, fish, and others. Animal feed is meant to meet the physiological requirements for maintenance, growth, and reproduction of these animals, ultimately leading to the production of high-value food products such as meat, milk, eggs, and farmed fish.

Protein is particularly valuable in animal nutrition. Animals require a sufficient quantity of total protein in their diet, and must obtain it from their feed. While feeds also contain energy sources like grains and fats, along with minerals and vitamins, the quality and balance of dietary protein are essential for optimizing animal productivity and translating feed input into high-value animal protein output for human consumption. Further, the continued growth in demand for animal protein for human consumption necessitates identifying and using sustainable and efficient protein sources for animal feed. Traditional sources, such as soy and fishmeal, face challenges related to land use, deforestation, and pressures on marine ecosystems. Consequently, alternative protein ingredients that can support high productivity levels in livestock and aquaculture while minimizing environmental impact can be beneficial in overcoming these challenges.

Insects have emerged as a promising alternative protein source for animal feed due to offering a high protein and unsaturated fat content comparable to or surpassing that of some conventional feed ingredients. Furthermore, insect biomass can be produced through highly resource-efficient processes, requiring significantly less land and water than traditional protein crops or animal farming. Many insect species can also convert organic by-products and waste streams into high-quality protein, contributing to a circular economy model and reducing the volume of organic waste. Protein from processed insects, such as insect meal, has demonstrated high digestibility and palatability in various animal species, including chicken and fish, making it a valuable component for inclusion in formulated animal feeds to support efficient growth and improve feed conversion ratios, thereby contributing to more sustainable and secure food production systems. In certain instances, the hard shell, chitin of certain insects, is used by poultry to grind or masticate their food since they don't have teeth, so they need something to reduce the food particle size to a manageable form. The grit, after ingestion, travels down into the gizzard where it will stay for quite a while until it is worn down sufficiently to pass through the bird without causing harm. Once it settles there, it goes to work helping the muscular gizzard to grind down the food into a nutritious paste from which the gut absorbs all the nutrients and water before eliminating the waste.

While the utilization of insects for food and feed has historical roots, traditional methods for their acquisition, such as manual foraging, simple trapping using light or pitfalls, or smoke or gas collection, present significant insufficiencies for establishing a consistent and scalable supply chain. These traditional techniques lead to unpredictable and often low yields that are inherently labor-intensive. Smoke- and gas-based collection can introduce environmental contaminants, posing considerable challenges for quality control and ensuring the purity and safety of the final product. Further, electricity-based means for killing insects for pest control purposes often damage insects to the point that they are unusable as feed. Difficulties also exist in implementing standardized and hygienic killing and processing procedures under these traditional approaches, limiting their applicability for providing reliable volumes of high-quality insect biomass suitable for animal feed or even direct human consumption. Cultivating insect larvae as animal feed in Asia has demonstrated limited protein and fat content due to the stage of growth when the larvae are fed to animals because cultivating insect growth past the larval stage is problematic. Further, trials have shown that feeding too much artificially grown larvae to poultry damages the taste of the protein to humans.

Embodiments described herein address these and other issues by providing for the efficient harvesting of insects in a manner that can provide a sustainable protein source for animal feed and complement other farming types. More specifically, an insect-harvesting device can include one or more printed circuit boards (PCBs) can have a plurality of exposed conductive tines that are interleaved such that insects are shocked (and potentially killed) when touching the tines. The PCBs can further have a variety of attractants to attract insects to the tines for harvesting. This can include, for example, various types of lights, chemicals, sounds/vibrations, and the like. Moreover, steps can be taken to help ensure certain beneficial insects, such as pollinators, are not harvested. Details are provided in the embodiments described below.

The embodiments described herein provide various advantages over traditional harvesting means. By using a PCB-based design, for example, embodiments can provide for economical, precise, and consistent manufacturing. By using specifically tuned voltages, embodiments can provide for the harvesting of insects in a manner that preserves their nutrition as a protein source for animal (or even human) consumption without introducing potentially harmful chemicals into the food chain. Further, by using a solar-powered battery as a power may be used, including different types of light (e.g., colors, amplitudes, strobing patterns, etc.), sound (e.g., frequencies/pitches, amplitudes, sound patterns, etc.), semiochemicals (e.g., pheromones and kairomones) that can be used together or source, embodiments can be used as standalone devices that can be deployed virtually anywhere, including remote rural areas where sufficient, large quantities of pestiferous insects are available, and may be infesting crops. Further, the attractants (e.g., lights, sounds, chemicals) and killing voltages may be specifically tuned to one or more targeted insects, enabling embodiments to reduce specific agricultural pests that may be infesting crops. These and other advantages will become apparent in view of the embodiments described in detail below.

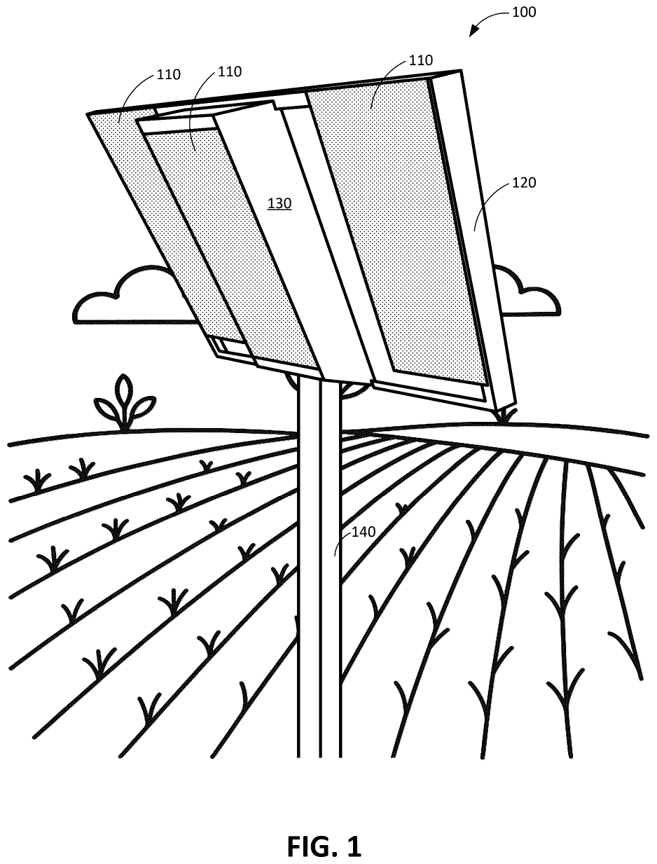

FIG. 1 is an image of an example insect harvesting unit 100, according to an embodiment. As with other figures provided herein, FIG. 1 is provided as a non-limiting example for illustrative purposes. For example, although the insect harvesting unit 100 is shown as being deployed on a pole 140 in or near a field of crops, alternative embodiments may be attached to various types of structures (e.g., floating devices, mobile or stationary structures, fences, etc.) and/or at various locations, including natural habitats, above bodies of water (e.g., ponds) for aquaculture, etc. Further, various components of the insect harvesting unit 100 may be differently arranged (e.g., with components combined, separated, added, omitted, rearranged, etc.) than shown in the configuration of FIG. 1. Additional examples are provided below.

The insect harvesting unit 100 may comprise one or more harvesting PCBs 110 with electrical tines capable of shocking and killing insects. As previously noted, to draw the insects to the harvesting PCBs 110, the insect harvesting unit 100 may include a variety of attractants, including lights, sounds/vibration, chemicals, and the like. These attractants may be located on the harvesting PCBs 110 and/or elsewhere in or on the insect harvesting unit 100. Different natural or synthetic, commercial, or proprietary attractants separately on, in, or around the harvesting PCBs 110 to attract specific insect populations and type of sex. Kairomones are used traditionally to attract female insects to reduce reproduction. The attractant and combinations thereof may be selected based on the period of operation (e.g., diurnal or nocturnal) and specific environments of regions, states, or countries around the world in which the insect harvesting unit 100 is used to harvest insects. These environments may have different climates and vegetation, and may comprise farms, urban areas, mountains, pastures, or fields. Environments may further have features including natural or man-made lights, fields, rivers, ponds, or lakes, all of which affect densities of specific species of insects.

In different embodiments, harvesting PCBs 110 can be any shape, including round, square, rectangular, hexagonal, or flat, and size ranging from inches to many yards. Multiple harvesting PCBs 110 may be attached together to create shapes and/or structures such as squares, cubes, triangles, triangular prisms, or other polyhedra. Multiple harvesting PCBs 110 may be affixed on a substrate to create a larger surface area, e.g., on the scale of a billboard. The substrate of the harvesting PCB(s) 110 can be flexible or rigid and made of natural or synthetic material, including, but not limited to metal, acrylic, polycarbonate, ceramic, cardboard, fiberglass, plastic, glass, wood, or any combination thereof, and coated with any type of reenforcing, conductive, plating, finishing, sealant, or other protective material or solutions, or any combination thereof.

In an example embodiment, the dimensions of a harvesting PCB 110 are 13.25 inches by 11.5 inches, enabling the panel to fit into a “standard” United States Post Office mailing box for economical shipping. Further, according to some embodiments, harvesting PCBs 110 may be replaced after a certain period of use (e.g., annually). According to some embodiments, such as the embodiment illustrated in FIG. 1, the insect harvesting unit 100 is designed to power and use 1 to 3 harvesting PCBs 110 concurrently.

According to experimental data, this can enable one insect harvesting unit 100 to harvest more than 15 lbs of protein/week or 2,730 lbs annually. This can sustain more than 40 broiler chickens through each of their 7-9 annual 6-week growth cycles, which may be seen as a threshold for commercial viability in the poultry industry. This amount of protein would cost as much as $10,000 from alternative sources in certain geographic locations, like Hawaii, which is almost ten times the cost of manufacturing one unit.

The insects attracted to the harvesting PCBs 110 are caught live, stunned, or killed based on the voltage and current selected based on the targeted type of insect(s). As explained in more detail in the embodiments described below, the electricity used to shock insects may be distributed by wires or on grid systems or with positive and negative traces (and/or other exposed conductors) on harvesting PCBs 110, which may be printed positive and negative tines comprising materials, such as silver, gold, copper, aluminum, and/or nickel on a substrate or surface screen. The insects caught live, stunned, or killed can drop onto the ground or surface and/or captured by fans, vacuums, bags or other types of collection receptors or containers, and/or preserved by natural or synthetic chemical solutions, drying or freezing as a protein, whole, ground to pieces or into a powder and packaged.

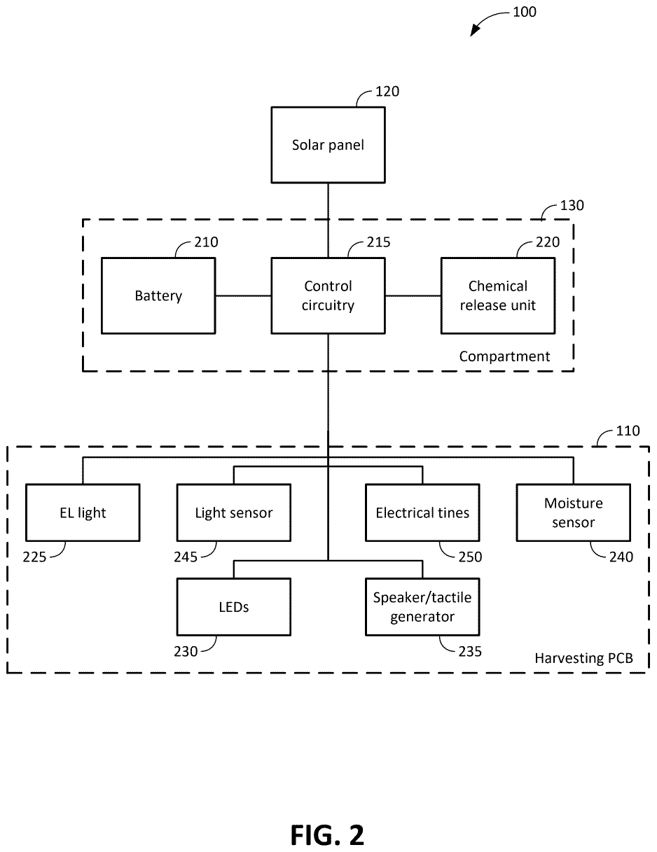

The insect harvesting unit 100 may be powered by a solar panel 120, and power storage may be provided by a battery in a compartment 130. The compartment 130 may also house control circuitry used to control at least a portion of the functionality of the harvesting PCBs 110, and/or chemical attractants. This enables the insect harvesting unit 100 to operate as a standalone unit, as previously noted, without the need for a separate power source. Additional details regarding the various components of the insect harvesting unit 100 are described below concerning FIG. 2.

Additional or alternative features may be implemented, depending on desired functionality. For example, according to some embodiments, the insect harvesting unit 100 can be powered by alternating current (AC). Depending on the desired functionality, the insect harvesting unit 100 may operate during different periods of the day or continuously indoors or outdoors. The location, functions, and operations of the insect harvesting unit 100 can be automated by one or more sensors to control periods of operations, moisture, or rain and snow on the insect harvesting unit 100. Additionally, or alternatively, the insect harvesting unit 100 may be operated manually or controlled remotely by on-board printed circuit boards and remote communication controlling the device and reporting density levels and counts of insects and weather conditions at the location of the device's installation.

The insect harvesting unit 100 may be used indoors or outdoors, and, according to some embodiments, may be freestanding in urban areas, mountains, pastures, farm fields, etc., and/or attached to poles, affixed on or in proximity to portable or mobile structures housing poultry or farm-raised animals. According to some embodiments, the insect harvesting unit 100 may be deployed around or on natural or man-made water features, containments, ponds, lakes, bays, reefs, and/or oceans containing any type of wild and/or cultivated fish for breeding, bait, and/or human consumption.

FIG. 2 is a block diagram of the electrical components of an example insect harvesting unit 100, which may correspond to the example insect harvesting unit 100 of FIG. 1. Lines between the various components represent electrical power and/or communication between such components, which may be bidirectional or unidirectional, as needed. Similar to FIG. 1, the primary components of the insect harvesting unit 100 illustrated in FIG. 2 include a harvesting PCB 110, a solar panel 120, and a compartment 130, which may be arranged as illustrated in FIG. 1. As noted in FIG. 1, a particular insect harvesting unit 100 may have multiple harvesting PCBs 110, depending on desired functionality. Again, FIG. 2 is provided as an example, and alternative embodiments may be differently arranged, depending on desired functionality. Further, as a person of ordinary skill in the art will appreciate, embodiments may include various support components (e.g., cooling fans, transformers, etc.) that are not shown in FIG. 2. Some embodiments may include one or more wireless communication radios (e.g., cellular) to enable the insect harvesting unit 100 to be monitored and/or controlled remotely via wireless communication with a remote server and/or other device.

The solar panel 120, or photovoltaic module, may be used to generate the electrical power used to run the insect harvesting unit. According to an embodiment, the solar panel 120 may comprise a 100-watt (W) solar panel, capable of powering three harvesting PCBs 110. Alternative embodiments, however, may have larger or smaller solar panels, and/or may have a different number of solar panels 120, depending on desired functionality. Moreover, the solar panel may include a metal frame (e.g., an aluminum frame) upon which other components (e.g., harvesting PCB(s) 110 and/or compartment(s) 130) may be mounted.

The battery 210, which may be located in the compartment 130 as previously noted, stores the energy, or power, collected by the solar panel 120, and provides power to the rest of the electrical components of the insect harvesting unit 100. Generally speaking, the battery 210 may be of sufficient storage capacity (e.g., watt-hours (Wh)) and output capacity (e.g., voltage (V), W, etc.) to power the electrical components for periods (e.g., nighttime) during which the solar panel 120 is producing little or no electricity. According to some embodiments, for example, a battery may be selected to enable the insect harvesting unit 100 to operate continuously for 12 hours. Other embodiments may select batteries larger or smaller, respectively, to operate for longer or shorter periods (which may be based on the length of nighttime periods at a location and during a season at which the insect harvesting unit 100 is intended to be deployed). Accordingly, embodiments may utilize a battery 210 with different sizes, shapes, capacities, compositions, etc. According to some embodiments, a deep-cycle battery may be used to help ensure an extended lifespan under cycling conditions, which typically involve charging during the day and discharging at night. Such deep-cycle batteries may include, for example, flooded lead-acid, AGM, gel, lithium-ion, and other lithium-based batteries. According to an embodiment, for example, a 3.2V, 100 amp hour (Ah) lithium iron phosphate (LiFePO4) is used for the battery 210. Alternative embodiments may use other batteries of different types, compositions, capacities, etc.

The control circuitry 215 may comprise circuitry to control the operation of the various electrical components shown in the diagram of FIG. 2. This includes, for example, a controller to manage the charging of the battery 210, the operating and/or operating voltage of various electrical components, step-up voltage for shocking and killing insects, etc. As such, the control circuitry 215 may comprise one or more microprocessors, supporting integrated circuits (ICs), discrete components (capacitors, transistors, etc.), and the like. The various components of the control circuitry 215 may be disposed on and electrically coupled via one or more PCBs (which may be distinct from the harvesting PCB 110). The control circuitry may control or activate external devices, such as insect mating disruption dispensers with cellular, radio, LoRaWAN, or other remote communication technology.

The chemical release unit 220 may comprise one or more electrically-controlled components intended to manage how chemical attractants are released into the environment in which the insect harvesting unit 100 is deployed. This can include, for example, heat elements, fans, vents, valves, and the like. According to some embodiments, for example, a chemical attractant is kept within the compartment 130, and the chemical release unit 220 comprises electrically-controllable vents that open to allow the chemicals to release into the air outside the compartment 130 and/or events to facilitate this release. Although chemicals are illustrated as the only insect attractant within the compartment 130, embodiments are not so limited. Additional attractants may be included in the compartment 130, and/or the chemical release unit 220 (and the chemical(s)) may be located outside the compartment 130 in some embodiments.

It can be noted that different chemicals may be used, depending on which insect(s) is/are targeted for harvesting. Generally put, semiochemicals are chemicals used by insects to attract each other. Thus, one or more semiochemicals including synthetic semiochemicals and/or kairomones for females may be used in the insect harvesting unit 100 to attract one or more types of insects or sex thereof. Semiochemicals include (i) pheromones, which are used within insects of the same species as sex attractants, trail marking compounds, alarm substances, and many other intraspecific messages; and (2) allelochemicals, which are used between different species as compounds used to locate suitable host plants, as well as a vast array of other substances that regulate interspecific behaviors. Insects use their sense of taste or smell to detect the presence of semiochemicals, which may be used to attract insects over very long distances. Synthetic semiochemicals can be used concurrently to reduce the mating of insects or the volumes of reproduction of certain species of insects to assist farmers in controlling those species of insects below economic threshold levels.

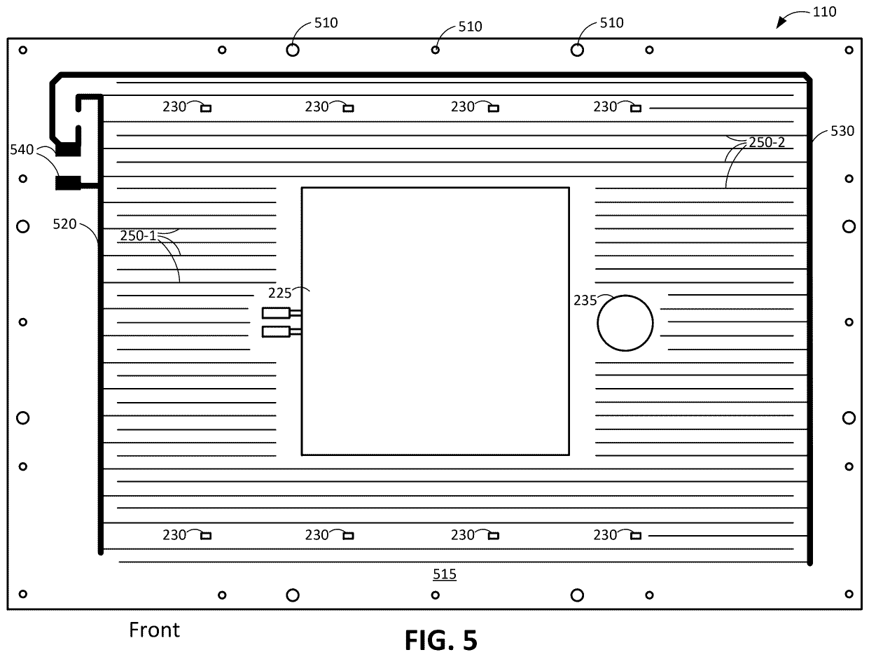

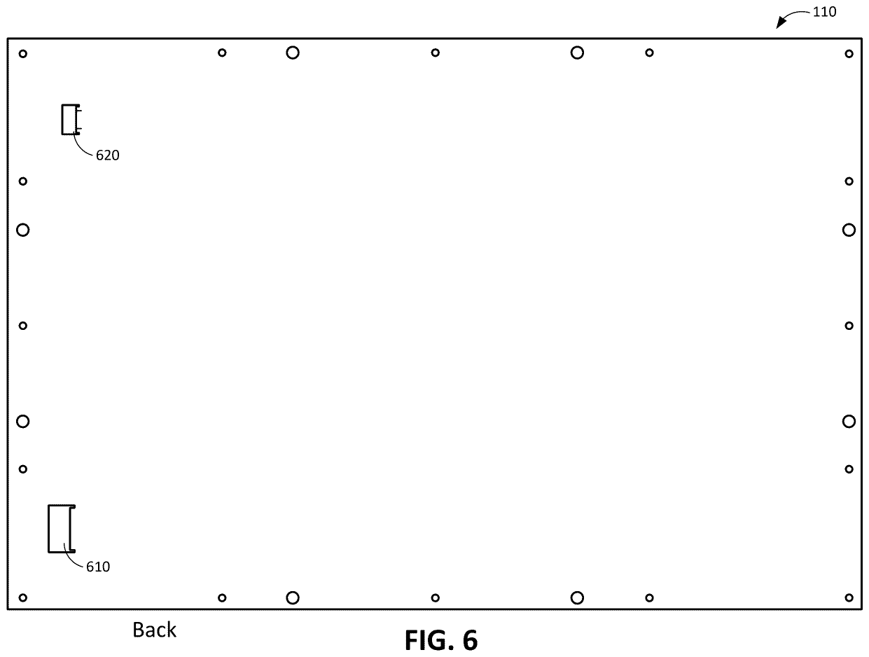

Components of the harvesting PCB 110 illustrated in FIG. 2 can be categorized into (1) insect attractants, which include light sources (electroluminescent (EL) light 225 and light emitting diodes (LEDs) 230) and speaker/tactile generator 235; (2) management components, which include moisture sensor 240 and a light sensor 245; and (3) insect killing components, which includes the electrical tines 250. These components may be coupled to and/or embedded in the harvesting PCB. Further, because the harvesting PCB 110 is exposed to an outside environment, the components of the harvesting PCB 110 may be selected not only for functionality, but also for durability when exposed to sunlight, heat, moisture, etc. An example PCB, including the layout of various components, is shown in FIGS. 5 and 6, which is described in more detail below.

Electroluminescent light 225 and LEDs 230 may be used to provide light attractants to insects. As with other attractants used in a particular embodiment, the electroluminescent light 225 and LEDs 230 may be optimized to attract one or more types of insects. LEDs 230 can be used to emit specific wavelengths, while the electroluminescent light 225 can cover a broad spectrum that may complement the wavelengths of the LEDs 230. As such, the electroluminescent lights 225 may comprise phosphor materials that emit light (typically in different constructional configurations than the semiconductor PN junctions found in LEDs). In some embodiments, an EL electroluminescent light 225 may comprise an EL panel that emits light from phosphor layer between conductive plates when AC current is applied to the conductive plates. (The insect harvesting unit 100 (e.g., control circuitry 215) may include an inverter to provide the AC current using electricity from the battery 210.) In some embodiments, the electroluminescent light panel may be applied onto the PCB 110 with 0.005 inch thick 3M™ Adhesive 200MP, that is packaged and potted for waterproofing the light component.

According to some embodiments, LED lights may emit wavelengths including 365 nm (UV light), 400 nm (blue), 550 nm (green), and/or other frequencies. According to some embodiments, at least one LED 230 may be configured to emit light with a wavelength between 365 and 550 nm. Electroluminescent light 225 and/or LEDs 230 may also be controlled (e.g., using a microprocessor or other controlling circuit within the control circuitry 215) to strobe or flash with a predetermined frequency. This may, for example, mimic the flashing of bioluminescent light emitted by certain insects. Again, this may be tuned to attract particular insects. In addition, or as an alternative to electroluminescent light 225 and/or LEDs 230, traditional incandescent (e.g., high-efficiency) and/or other types of lights may be used.

The speaker/tactile generator 235 may provide sounds and/or vibrations to attract the targeted insect(s). This may include a single component or multiple components, depending on the desired frequencies and/or amplitude. According to some embodiments, the speaker/tactile generator may comprise a piezoelectric speaker capable of generating various audio and/or tactile signals that may serve as attractants to various types of insects. According to some embodiments, this may include relatively low frequencies (e.g., 300 Hz or lower) and/or relatively high frequencies (including ultrasonic frequencies above 20 kHz, such as up to 80 kHz or higher). In addition, or as an alternative to a piezoelectric speaker, other technologies may be used for generating audio and/or tactile output. These technologies may include traditional dynamic (moving-12 magnetic) speakers, electrostatic speakers, planar magnetic speakers, and the like.

The light sensor 245 can be used to help ensure that the insect harvesting unit 100 operates at particular times of day. For example, the light sensor 245 can detect when light falls below a threshold level, reflecting light levels at dusk or twilight. At this point, the control circuitry 215, which may receive the sensor input from the light sensor 245, may activate the various insect attractants (e.g., electroluminescent lights 225, LEDs 230, speaker/tactile generator 235, chemical release unit 220) and electrical tines 250. The light sensor 245 can also be used to detect dawn, at which point the control circuitry 215 may deactivate the insect attractants and electrical tines 250. Nighttime operation in this manner can help ensure that harvesting is limited to insect pests, which are primarily nocturnal, and not beneficial pollinating insects, which are diurnal. This can be of particular importance for insect harvesting unit 100 deployed on farms and orchards, where both reducing populations of pest insects and maintaining pollinating insect populations are desired. In addition, or as an alternative to, the light sensor 245 being located on the harvesting PCB 110, the light sensor 245 may be located on the compartment 130 and/or the solar panel 120.

The moisture sensor 240 can be used to help ensure that the insect harvesting unit 100 does not operate during moist conditions, particularly during a rainstorm, which could cause the electrical tines 250 to short. The moisture sensor 240 may be a stand-alone sensor as illustrated, and/or may be integrated into the electrical tines 250 as a short detector. (E.g., the control circuitry 215 may include the moisture sensor 240, which monitors and detects a short in the electrical tines 250. A short due to water may be distinguishable from the shock provided by an insect based on current and/or resistance differences, duration of a detected closed circuit, etc.) The control circuitry 215 may receive an output of the moisture sensor 240, such that if moisture (e.g., a short) is detected, the control circuitry 215 can deactivate the electrical tines 250. Optionally, the control circuitry 215 may also deactivate other components (e.g., insect attractants). According to some embodiments, the control circuitry 215 may periodically check the output of the moisture sensor 240 (e.g., every one, two, three, five, or 10 minutes, etc.) to determine whether moisture is present. If moisture (e.g., a short) is no longer detected, the control circuitry 215 may reactivate the electrical tines 250 and any other components that may have been deactivated.

As previously indicated, the electrical tines 250 may comprise exposed, electrically conducting material used to kill insects attracted to the harvesting PCB 110. (As used herein, an “exposed” tine comprises a tine made from conductive material, at least a portion of which is not covered by an electrically insulating material, so that the conductor is exposed to outside elements, potentially making an electrical connection with objects (e.g., insects) with which the uncovered portion comes into contact.) As described in more detail with respect to FIG. 5, the electrical tines may comprise conductive traces of the PCB that do not have a polymer film layer (e.g., solder mask or solder resist) used as an insulating layer in traditional PCB manufacture. The electrical tines may comprise conductive material used in PCB manufacture, such as copper, nickel, silver, gold, or aluminum. Copper and nickel are used as both durable and very conductive, but economical materials for these purposes. It can be noted, however, that polymers used to suspend particles of copper and nickel in liquid printed tracers may not be able to sustain the high voltage required to kill many targeted species of insect, in some embodiments. Thus, some embodiments may use solid electrical tines 250 without polymers. Sets of tines may operate as electrodes with different voltages (e.g., positive and negative) and may be interleaved and spaced such that an insect that touches or lands on the harvesting PCB 110 touches at least one tine from each set and is shocked. Due to the precise spacing of electrical tines 250 and positioning and laying the electrical tines 250 onto the substrate of the harvesting PCB 110 afforded only by PCB manufacturing processes, this circumvents resulting operating problems of other fabrication methods and reduces the accumulation of dendrites developing from moisture accumulating between the tines, causing terminal shorts. This is a benefit of using a PCB-based design.

As with other components of the insect harvesting unit 100, aspects of the electrical tines 250 may be optimized for one or more targeted insects. This can include, for example, the spacing and voltage of the electrical tines 250. According to some embodiments, the electrical tines 250 may be 10 mils wide and 250 mils apart, for example. According to some embodiments, the electrical tines 250 may be between 5-20 mils wide and 100-500 mils apart, for example. Other embodiments may have larger or smaller spacing, depending on the desired functionality. The voltage of the electrical tines 250 may be tuned to help ensure insects are shocked (stunned or killed), but the nutritional value of the insects is preserved. Thus, embodiments may operate at voltages far lower than traditional electrical means for killing insects, which operate at voltages from 500 V to 5 kV or more. For example, according to some embodiments, the voltage of the electrical tines 250 may be between substantially 80 and 185 V.

According to some embodiments, the control of the various attractants of the insect harvesting unit 100 and the voltage of the electrical tines 250 may be “tuned” to attract and kill one or more types of targeted insects, which may vary depending on where the insect harvesting unit 100 is deployed. Insects harvested in the Philippines may differ from those harvested in Ecuador, which may differ from those harvested in the American southeast due to climate and resulting vegetation, for example. Thus, the attractant(s) audio, sound vibrations, visual (light frequency), and/or semiochemicals are pre-selected in a “recipe” at the factory (or otherwise prior to deployment), each based on geographic location used and, optionally, the type of cultivated crops grown, which can determines species insect infesting specific crop types. As an example, in the southeast United States, a recipe would combine LEDs 230 and/or electroluminescent light 225 to generate light having a wavelength between 530 nm and 540 nm to harvest species of beetles such as the emerald ash borer. The recipe would include audio in the 300 Hz to 500 Hz range, generated by the speaker/tactile generator 235. Whereas in California, where 67% of the fruit and vegetables consumed in the U.S. are grown, the recipe may use 365 nm (UV) light frequencies and semiochemicals and kairomones, and further include no audio attractant, to harvest moths, such as Amyelois transitella, the navel orangeworm, which infest nut orchards. Each recipe may incorporate a voltage level for the electrical tines 250, selected based on the size of the target insect, so insects are not burned or blown up, preserving the nutrition of the insect for animal feed.

Because various types of attractants for the insect harvesting unit 100 may have differing effectiveness over different distances, they may be used in combination, as provided in the embodiments described herein, to increase the effectiveness of the insect harvesting unit 100. More specifically, the use of chemical, aural/vibratory, and visual attractants as described herein is based on trials and the need for greater effectiveness. Semiochemicals and kairomones are effective over the longest distance of the attractants but may be adversely affected by wind and humidity. Insects are attracted to higher concentrations of the chemicals, so they fly towards the area where the unit is deployed. Light is more consistent, not affected by wind and humidity, and is more concentrated, staged to attract insects in the area (which may have been drawn to the area by the chemical attractants) directly to the insect harvesting unit 100. Sound/vibration may be the least effective over distance. However, insects near the insect harvesting unit 100 (which may have been drawn by the chemicals and light) may be drawn to the surface of the insect harvesting unit 100 by the sound/vibration to be electrocuted. Thus, the different types of attractants may be deliberately used based on effectiveness over distances.

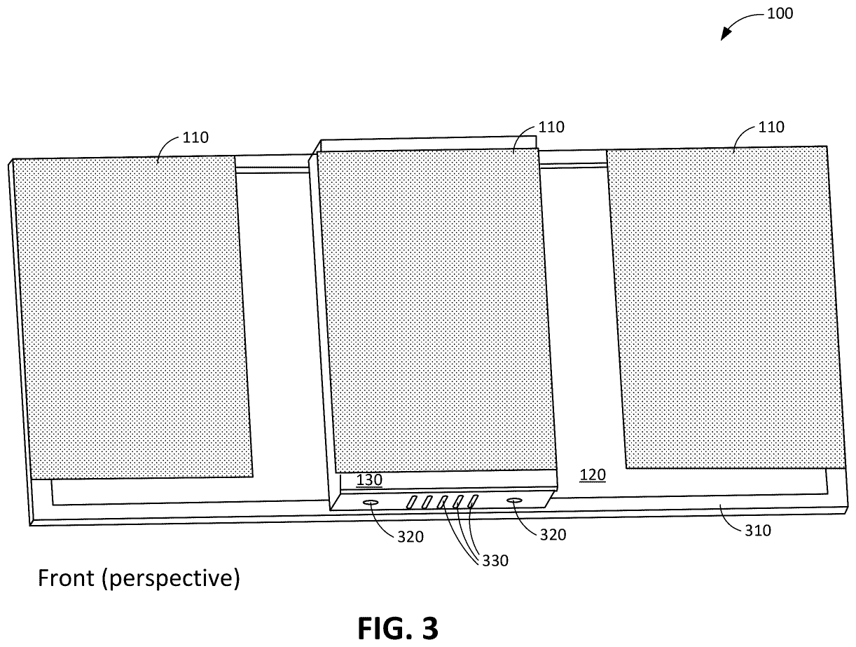

FIG. 3 is a perspective drawing of the front of an insect harvesting unit 100, according to an embodiment. In this example, similar to FIG. 1, three harvesting PCBs 110 and a compartment 130 are mounted to the frame 310 of a solar panel 120. The compartment 130 may include holes 320 that may be used for mounting and/or access to internal components with grommets to keep insects that destroy electrical circuitry, such as fire ants. Additionally, the compartment 130 may comprise vents 330 to allow for heat release and to enable the semiochemicals housed within the compartment 130 to permeate outside the compartment 130, as described above. Alternative embodiments may have alternative configurations of mounting/access holes 320 and/or vents 330. It can be noted that control circuitry 215 (not shown in FIG. 3) housed within the compartment 130 may be electrically connected with each of the harvesting PCBs 110 via wires (also not shown) to provide the functionality described herein.

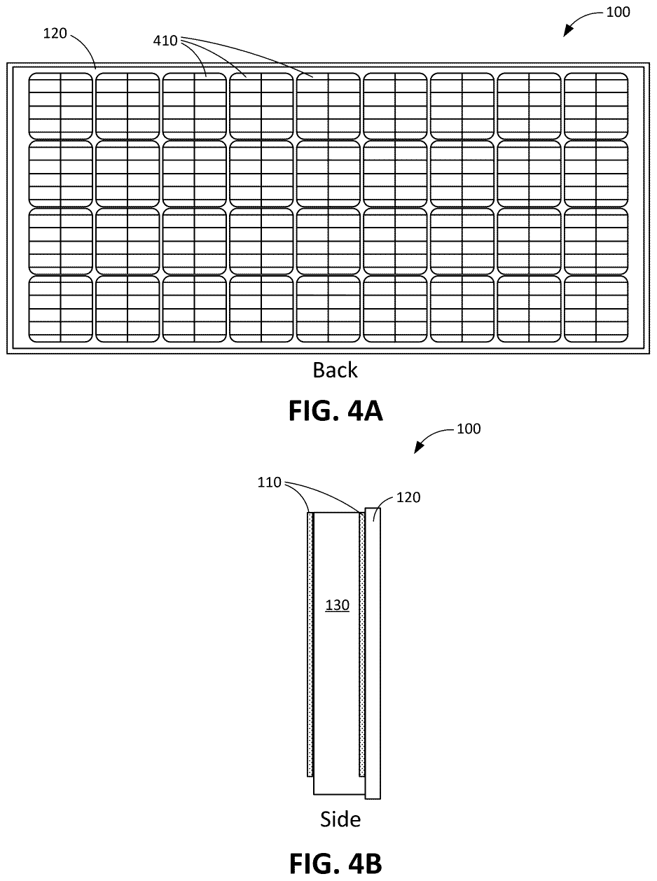

FIG. 4A is a drawing of the back of an insect harvesting unit 100, according to an embodiment. As illustrated, this can include solar cells 410 of the solar panel 120, and the back may be angled upward (e.g., as illustrated in FIG. 1) to help optimize the production of electricity to power the insect harvesting unit 100. The configuration (arrangement, size, etc.) of the solar cells 410 may vary, depending on the type of solar panel 120 used. (It can be noted that only a portion of the solar cells 410 are labeled, to avoid clutter.)

FIG. 4B is a drawing of a side view of an insect harvesting unit 100, according to an embodiment. As can be seen, harvesting PCBs 110 may be mounted to the solar panel 120 and compartment 130. As described in more detail hereafter, however, other configurations may be implemented, depending on desired functionality.

FIG. 5 is a drawing of a front view of a harvesting PCB 110, according to an embodiment. This illustration is provided as an example layout of components on a harvesting PCB 110, and alternative embodiments may vary from the illustration. Specifically, alternative embodiments may have a larger or smaller number of various components, additional or alternative components, may omit specific components, rearrange or otherwise vary components, as desired. It can be noted that some conductive traces (traces powering various components mounted on the harvesting PCB 110) are not shown to avoid clutter. (These conductive traces may or may not be visible, depending on which layer in the PCB manufacturing process is used to form the conductive traces.)

In the example in FIG. 5, the harvesting PCB 110 has a plurality of mounting holes 510 (only a portion of which are labeled) near the edges. These mounting holes can serve not only to mount the harvesting PCB 110 on a solar panel frame 310 or body of a compartment 130, but may enable mounting on other hardware and/or components. Moreover, according to some embodiments, other components, such as baskets or bags to capture shocked insects, may be mounted on the harvesting PCBs 110 using one or more of these mounting holes.

Other components correspond with the components discussed above with respect to FIG. 2. This includes electroluminescent light 225, LED lights 230, and speaker/tactile generator 235. Again, aspects such as the size, placement, and number of these components may vary, depending on desired functionality. Generally put, these attractants are located next to the electrical tines 250, which extend along a surface 515 of the harvesting PCB 110. The attractants, disposed in or on the surface 515, attract insects to the harvesting PCB 110 such that they land on or otherwise touch the electrical tines 250 and are shocked. As noted previously, electrical tines 250 may be exposed to help ensure that a shock is given to insects that touch the electrical tines 250. Other components, however, may be sealed with a UV protective and/or moisture-resistant laminate covering.

The electrical tines 250 are grouped into two sets: a first set of electrical tines 250-1 and a second set of electrical tines 250-2. As illustrated, tines of the first set of electrical tines 250-1 are connected with a first conductive trace 520 that may be have a first polarity (e.g., negative), and the second set of electrical tines 250-2 are connected with a second conductive trace 530 that may have a second polarity (e.g., positive), such that a voltage is created between the first set of electrical tines 250-1 and the second set of electrical tines 250-2. Conductive traces 520 and 530 are connected with respective conductive pads 540, which are electrically connected with an electrical connector on the other side of the harvesting PCB 110 that provides high-voltage electrical power (e.g., 80-185 V) from the control circuitry. The tines of the first set of electrical tines 250-1 are interleaved with and run substantially parallel to the tines of the second set of electrical tines 250-2 to help ensure that insects that touch the harvesting PCB 110 will touch tines from both sets, thereby receiving an electrical shock, which can stun or kill the insect. It can be noted that alternative embodiments may have different patterns of tines than those shown in FIG. 5. Instead of substantially horizontal lines, for example, tines 250 may extend diagonally, vertically, in a spiral or raster pattern, etc., or a combination thereof.

FIG. 6 is a drawing of a back view of the harvesting PCB 110 illustrated in FIG. 5. According to some embodiments, because the back of the harvesting PCB 110 may not be accessible to insects when the harvesting PCB 110 is mounted to the rest of the insect harvesting unit 100, it may not include any insect attractants or electrical tines. Instead, as illustrated, the back of the harvesting PCB 110 includes two electrical connectors. Each connector may connect wires from the control circuitry 215 in the compartment 130 to the harvesting PCB 110. A first electrical connector 610 relays the high-voltage electricity for the electrical tines 250, and a second electrical connector 620 relays low-voltage electricity and communication lines to power the various components of the harvesting PCB 110 and relay communication between these components and the control circuitry.

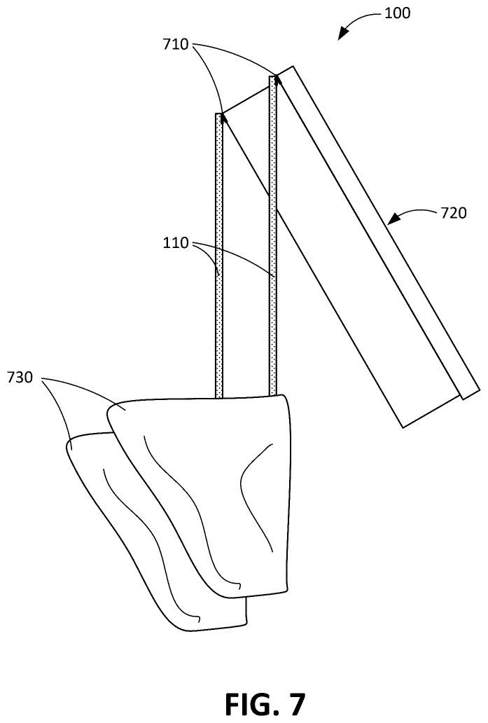

As previously noted, not only can the operation of the insect harvesting unit be modified to target specific types of insects, but the configuration also may be modified to enable different types of deployment, depending on the application. An insect harvesting unit may be mounted on poles, fences, buildings, buoys, etc. FIGS. 7-9 illustrate some nonlimiting examples of different configurations.

FIG. 7 is an illustration of a side view of an insect harvesting unit 100 (similar to FIG. 4B), with a couple of modifications from previously illustrated embodiments. First, the harvesting PCBs 110 are mounted by hinges 710 at the respective top edges. This allows the insect harvesting unit 100 to hang vertically from the insect harvesting unit 100 when the surface of the solar panel 720 is angled upward to help optimize sunlight collection. Hanging vertically in this manner (rather than downward facing, mounted without hinges) can allow for audio and visual attractants mounted on the harvesting PCBs 110 to reach further distances, potentially attracting more insects.

Second, this embodiment includes insect collecting apparatuses 730 mounted on the harvesting PCBs 110 to facilitate the collection of insects that are shocked by the harvesting PCBs 110. Different types of collection apparatuses (e.g., baskets, bags, or other types of collection receptors or containers) may be used in different embodiments. In this example, bags may be used with a wireframe to help keep the mouth of the bag open for insect collection. According to some embodiments, the mounting holes (e.g., mounting holes 510) on the harvesting PCBs 110 may be used to mount the insect collecting apparatuses 730.

It can be noted that many applications without insect collecting apparatuses 730 may be used. An insect harvesting unit 100 may be mounted on a pole in an area in which chickens are grown, which enables shocked insects to fall to the ground and feed the chickens. Similarly, an insect harvesting unit 100 may be mounted on a buoy or pole above a pond or other body of water in which fish are grown, allowing the fish to feed on the shocked insects.

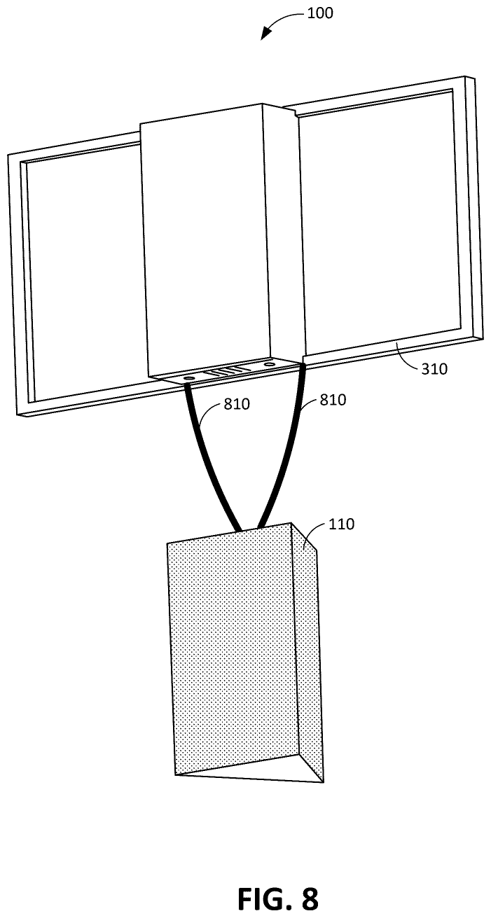

FIG. 8 is an illustration of yet another configuration of an insect harvesting unit 100, according to an embodiment. Here, rather than (or in addition to) harvesting PCBs 110 being mounted directly to the solar panel frame 310, the harvesting PCBs 110 are suspended from the rest of the insect harvesting unit 100 via cables 810. As illustrated, three harvesting PCBs 110 are mounted back to back to form a triangular prism. The harvesting PCBs 110 face outward, so the attractants mounted on the harvesting PCBs 110 are visible from all directions. This particular configuration may be useful, for example, when the insect harvesting unit 100 is suspended from a structure (e.g., the eave of a roof).

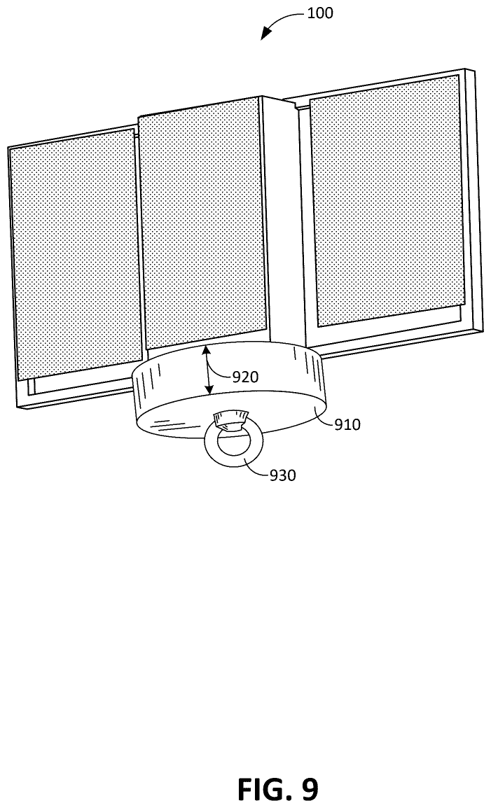

FIG. 9 is an illustration of another configuration of an insect harvesting unit 100, according to an embodiment. In this configuration, the insect harvesting unit is mounted to a buoy 910 that has sufficient height 920 and buoyancy to ensure the insect harvesting unit 100 always remains above the water, even during stormy conditions. The buoy 910 may comprise a handle 930 to which a chain or rope may be attached to secure the buoy to an anchor at the bottom of the body of water in which the insect harvesting unit 100 is located.

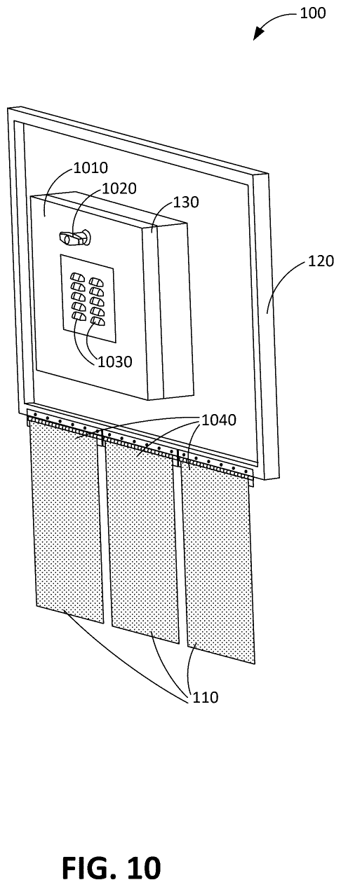

FIG. 10 is an illustration of another configuration of an insect harvesting unit 100, according to an embodiment. This configuration is like the configuration of FIGS. 1, 3, 4A, 4B, and 7, with some differences. These differences include a differently proportioned compartment 130 on the solar panel 120 with a door 1010 that is lockable via a lockable handle 1020. Vents 1030 for the compartment 130 are located on the door 1010. Additionally, the configuration of FIG. 10 locates the harvesting PCBs 110 at the bottom of the insect harvesting unit 100, movably attached via hinges 1040. The functionality of the various components (compartment 130, hinges 1040, vents 1030, etc.) may be the same or similar to that of corresponding components of other embodiments described herein. In contrast with other embodiments described above, this configuration allows internal access to the compartment 130 (e.g., for maintenance, activation, etc.) via door 1010. That said, other embodiments may include a door or similar component for analogous functionality. Further, alternative embodiments to those described herein may include any combination of components of the various embodiments described herein, depending on desired functionality.

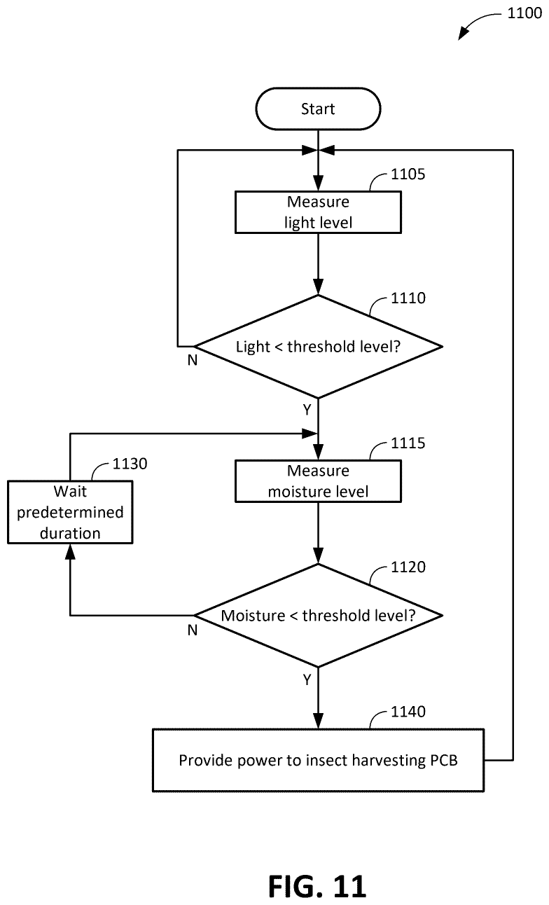

FIG. 11 is a flow diagram 1100 of a method for operating a device for harvesting insects, such as one or more harvesting PCBs 110, as described herein. Some or all of the functionality illustrated in FIG. 11 may be performed, for example, by control circuitry 215. As with other figures described herein, FIG. 11 is provided as a nonlimiting example, and various functions may be rearranged or altered, as needed. In some embodiments, for example, the measurement of light and moisture levels, for example, may be performed simultaneously. The method of diagram 1100 may be performed, for example, by the control circuitry 215 when the insect harvesting unit 100 is deployed and turned on. According to some embodiments, the method in FIG. 11 may be with respect to powering the electrical tines 250, and different functionality may apply to powering and/or managing the insect attractants and/or other electrically-powered functions performed by the one or more harvesting PCBs 110.

The method of the flow diagram 1100 can begin at block 1105, where a light level is measured. This may be performed, for example, by the light sensor 245 described in the embodiments above. As also discussed, the measurement of the light level can be used to determine whether it is nighttime, to help ensure insect pests, rather than pollinators, are harvested by the insect harvesting unit 100. Thus, as illustrated at block 1110, if a measurement from the light sensor indicates that the light measurement at the device is lower than a certain threshold (e.g., indicating nighttime), the light sensor will continue to measure the light level (at block 1105) until the light exceeds the threshold level. Depending on whether the light sensor is analog or digital, the measuring of the light level (at block 1105) may be continuous (e.g., in the case of analog) or periodic (e.g., in the case of digital).

Depending on desired functionality, the threshold level of light can be set and/or adjusted based on light levels in a particular location. For example, a user may be able to provide an input to the control circuitry 215 (e.g., via a button, dial, app, etc.) to set the threshold light level at which the insect harvesting unit 100 turns on/off. Different, lower light settings would be desired, for example, in forestry applications versus orchards where the spacing of trees is wider and/or row crop vegetable fields with less foliage from plants. Monitoring and conserving the power of all components of the insect harvesting unit 100 may be important to maintain levels of performance during cloudy days, which may extend the operating periods of the insect harvesting unit 100 for each 24-hour cycle. According to some embodiments, the threshold light level may be set at the factory.

According to some alternative embodiments, a timer, manual switch, or remote input may be used in lieu of the measurement of light. In certain applications, the insect harvesting unit 100 may be operated 24 hours (e.g., during post-pollination periods) to include harvest and control of diurnal insects. If the insect harvesting unit 100 is moved from Florida to California, the periods of operation could be set manually, adjusting for time differences. Additionally, or alternatively, if the harvesting PCB 110 is replaced or if insect harvesting unit 100 is serviced, the insect harvesting unit 100 could be turned off manually to avoid a human user being accidentally shocked by the electrical tines 250. That is, according to some embodiments, control circuitry may include a clock that may be preconfigured to power the insect harvesting PCB based on a schedule, in addition to, or as an alternative to, the use of a light measurement as shown in FIG. 11. The clock may be adjusted and/or preconfigured to account for differences in the day/night cycle based on location, seasons, time changes (e.g., daylight savings) etc. Additionally, or alternatively, for embodiments in which control circuitry is in communication (e.g., via a wireless radio frequency (RF) link) to a remote device (e.g., a computer server), the remote device may provide a signal or schedule of when to power the insect harvesting PCB on/off.

If the measurement of light exceeds a threshold level, the method may move to the functionality at block 1115, in which a moisture level is measured. This functionality may be performed, for example, by the moisture sensor 240 described in the embodiments above. Again, the moisture sensor 240 may detect a short in the electrical tines 250. If moisture is detected (e.g., moisture is greater than a threshold level), then the process can move to the functionality at block 1130, at which the method involves waiting a predetermined duration (e.g., 1, 2, 3, 5, 10 minutes, etc.) before taking another measurement of the moisture level. This process may be repeated until a moisture measurement falls below a threshold level. In the case of the moisture sensor 240 comprising a short detector, this may mean that the short is no longer detected. Once the moisture measurement indicates moisture below a threshold level, then the process can proceed with the functionality at block 1140, in which power is provided to the insect harvesting PCB.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example, and the claimed subject matter is not limited to this example. Furthermore, the term “at least one of,” if used to associate a list, such as A, B, or C, can be interpreted to mean any combination of A, B, and/or C, such as A, AB, AA, AAB, AABBCCC, etc.

In view of this description, embodiments may include different combinations of features. Implementation examples are described in the following numbered clauses:

Clause 1: A device for harvesting insects, the device comprising: a printed circuit board (PCB) having a surface; and a plurality of exposed conductive tines extending along the surface of the PCB, the plurality of exposed conductive tines comprising a first set of tines interleaved with a second set of tines, the first set of tines and the second set of tines being electrically connected with different electrical nodes such that, during operation of the device, a voltage is created between the first set of tines and the second set of tines during operation of the device.

Clause 2: The device of clause 1, wherein the device further comprises one or more insect attractants disposed on the surface of the PCB.

Clause 3: The device of clause 2, wherein the one or more insect attractants comprise one or more light sources.

Clause 4: The device of clause 3, wherein the one or more light sources comprise at least one light emitting diode (LED), at least one electroluminescent light, or a combination thereof.

Clause 5: The device of clause 4, wherein the one or more light sources comprise the at least one light emitting diode (LED), and the at least one LED is configured to emit light having a wavelength between 365-550 nm.

Clause 6: The device of any one of clauses 2-5, wherein the one or more insect attractants comprise a speaker configured to generate one or more frequencies between 300-550 Hz.

Clause 7: The device of any one of clauses 1-6, wherein the plurality of exposed conductive tines comprises conductive traces of the PCB.

Clause 8: The device of any one of clauses 1-7, wherein the device is configured to operate such that the voltage created between the first set of tines and the second set of tines during operation of the device is between substantially 80-185 V.

Clause 9: The device of any one of clauses 1-8, wherein tines of the first set of tines extend along the surface of the PCB substantially parallel to tines of the second set of tines.

Clause 10: The device of clause 9, wherein a spacing between a tine of the first set of tines and a tine of the second set of tines is between 100-500 mils.

Clause 11: The device of any one of clauses 1-10, wherein PCB further includes holes for mounting an insect-collecting apparatus to the device.

Clause 12: The device of any one of clauses 1-11, further comprising: a solar panel; a battery configured to receive and store power from the solar panel; control circuitry configured to receive power from the battery and provide the voltage to the PCB; and a compartment housing the control circuitry, the battery, or both.

Clause 13: The device of any one of clauses 1-12, further comprising one or more chemical insect attractants located inside the compartment.

Clause 14: The device of any one of clauses 1-13, further comprising a moisture sensor and a light sensor, wherein the control circuitry is configured to provide the voltage to the PCB based at least in part on: an indication, from the light sensor, that a level of light measured at the device is lower than a certain threshold, and an indication, from the moisture sensor, that a level of moisture measured at the device is lower than a certain threshold.

Clause 15: A method of operating a device for harvesting insects, the method comprising providing, with control circuitry, electrical power to a printed circuit board (PCB), wherein the PCB comprises a plurality of exposed conductive tines extending along a surface of the PCB, the plurality of exposed conductive tines comprising a first set of tines interleaved with a second set of tines, the first set of tines and the second set of tines being electrically connected with different electrical nodes such that a voltage is created between the first set of tines and the second set of tines when the electrical power is provided to the PCB.

Clause 16: The method of clause 15, further comprising operating one or more light sources located on the surface of the PCB, the one or more light sources comprising at least one light emitting diode (LED), at least one electroluminescent light, or a combination thereof.

Clause 17: The method of either of clauses 15 or 16, further comprising operating a speaker, located on the surface of the PCB, to generate one or more frequencies between 300-550 Hz.

Clause 18: The method of any one of clauses 15-17, wherein providing the electrical power comprises providing the voltage, wherein the voltage is between substantially 80-185 V.

Clause 19: The method of any one of clauses 15-18, wherein the control circuitry is coupled with a light sensor, and wherein providing the electrical power to the PCB is based, at least in part, on an indication from the light sensor to the control circuitry that a level of light measured at the device is lower than a certain threshold.

Clause 20: The method of any one of clauses 15-19, wherein the control circuitry is coupled with a moisture sensor, and wherein providing the electrical power to the PCB is based, at least in part, on an indication from the moisture sensor to the control circuitry that a level of moisture measured at the device is lower than a certain threshold.

What is claimed is:

1. A device for harvesting insects, the device comprising:
a printed circuit board (PCB) having a surface; and
a plurality of exposed conductive tines extending along the surface of the PCB, the plurality of exposed conductive tines comprising a first set of tines interleaved with a second set of tines, the first set of tines and the second set of tines being electrically connected with different electrical nodes such that, during operation of the device, a voltage is created between the first set of tines and the second set of tines during operation of the device.

2. The device of claim 1, wherein the device further comprises one or more insect attractants disposed on the surface of the PCB.

3. The device of claim 2, wherein the one or more insect attractants comprise one or more light sources.

4. The device of claim 3, wherein the one or more light sources comprise at least one light emitting diode (LED), at least one electroluminescent light, or a combination thereof.

5. The device of claim 4, wherein the one or more light sources comprise the at least one light emitting diode (LED), and the at least one LED is configured to emit light having a wavelength between 365-550 nm.

6. The device of claim 2, wherein the one or more insect attractants comprise a speaker configured to generate one or more frequencies between 300-550 Hz.

7. The device of claim 1, wherein the plurality of exposed conductive tines comprise conductive traces of the PCB.

8. The device of claim 1, wherein the device is configured to operate such that the voltage created between the first set of tines and the second set of tines during operation of the device is between substantially 80-185 V.

9. The device of claim 1, wherein tines of the first set of tines extend along the surface of the PCB substantially parallel to tines of the second set of tines.

10. The device of claim 9, wherein a spacing between a tine of the first set of tines and a tine of the second set of tines is between 100-500 mils.

11. The device of claim 1, wherein the PCB further includes holes for mounting an insect-collecting apparatus to the device.

12. The device of claim 1, further comprising:
a solar panel;
a battery configured to receive and store power from the solar panel;
control circuitry configured to receive power from the battery and provide the voltage to the PCB; and
a compartment housing the control circuitry, the battery, or both.

13. The device of claim 12, further comprising one or more chemical insect attractants located inside the compartment.

14. The device of claim 12, further comprising a moisture sensor and a light sensor, wherein the control circuitry is configured to provide the voltage to the PCB based at least in part on:
an indication, from the light sensor, that a level of light measured at the device is lower than a certain threshold, and
an indication, from the moisture sensor, that a level of moisture measured at the device is lower than a certain threshold.

15. A method of operating a device for harvesting insects, the method comprising providing, with control circuitry, electrical power to a printed circuit board (PCB), wherein the PCB comprises a plurality of exposed conductive tines extending along a surface of the PCB, the plurality of exposed conductive tines comprising a first set of tines interleaved with a second set of tines, the first set of tines and the second set of tines being electrically connected with different electrical nodes such that a voltage is created between the first set of tines and the second set of tines when the electrical power is provided to the PCB.

16. The method of claim 15, further comprising operating one or more light sources located on the surface of the PCB, the one or more light sources comprising at least one light emitting diode (LED), at least one electroluminescent light, or a combination thereof.

17. The method of claim 15, further comprising operating a speaker, located on the surface of the PCB, to generate one or more frequencies between 300-550 Hz.

18. The method of claim 15, wherein providing the electrical power comprises providing the voltage, wherein the voltage is between substantially 80-185 V.

19. The method of claim 15, wherein the control circuitry is coupled with a light sensor, and wherein providing the electrical power to the PCB is based, at least in part, on an indication from the light sensor to the control circuitry that a level of light measured at the device is lower than a certain threshold.

20. The method of claim 15, wherein the control circuitry is coupled with a moisture sensor, and wherein providing the electrical power to the PCB is based, at least in part, on an indication from the moisture sensor to the control circuitry that a level of moisture measured at the device is lower than a certain threshold.
